(19) United States
(12) Patent Application Publication
(10) Pub. No.: US 2002/0014940 A1
(43) Pub. Date: Feb. 7, 2002

(54) Ignition coil for an internal combustion engine

(75) Inventors: Eiichiro Kondo, Hitachinaka-shi (JP); Junichi Shimada, Mito-shi (JP); Yoichi Anzo, Hitachinaka-shi (JP); Kenji Nakabayashi, Hitachinaka-shi (JP); Hiroaki Saito, Naka-gun (JP)

Correspondence Address: CROWELL & MORING LLP, Intellectual Property Group, P.O. Box 14300, Washington, DC, 20044-4300, US

(73) Assignee: Hitachi Ltd.

(21) Appl. No.: 09/903,523

(22) Filed: Jul. 13, 2001

Related U.S. Application Data
(63) Continuation of application No. 09/406,682, filed on Sep. 27, 1999, now abandoned.

(30) Foreign Application Priority Data
Sep. 25, 1998 (JP) 10-271153

(51) Int. Cl. H01F 27/02

(52) U.S. Cl. 336/96

(57) ABSTRACT

A center core 1, a secondary coil 3 wound at a secondary bobbin 2 and a primary coil 5 wound at a primary bobbin 4 are placed concentrically inside a coil case 6 in sequence from the inside of the coil case. One end of the secondary coil 3 is connected to the primary coil side and becomes a low-voltage side, and the other side becomes a high-voltage side due to an induced voltage and used with connection to the individual ignition plugs of the internal combustion engine. The radial thickness of the bobbin at the low-voltage side 3a and the high-voltage side 3c of the secondary coil, each located at the both ends of the secondary coil, is made larger than the radial thickness of the bobbin at the center part 3b of the secondary coil. The radial thickness of an insulating layer 8 between the secondary coil 3 and the primary coil 5 at the low-voltage side 3a of the secondary coil is smaller and the radial thickness of the insulating layer at the high-voltage side 3b of the secondary coil is larger.

### BACKGROUND OF THE INVENTION

The present invention relates to an ignition system for internal combustion engines, especially to an ignition coil of independent ignition type installed inside the individual plug holes of the engine and used so as to be connected to the individual ignition plug.

In recent years, ignition coil systems of independent ignition type for internal combustion engines which are installed in the plug holes of the engine and connected separately to the individual ignition plugs are put to practical use. This type of ignition coil system is called in-plug installation type, because at least one part of its coil part is inserted and installed in the plug hole, and its coil part is called pencil coil because the coil part, which is inserted into the plug hole, is thus shaped like a pencil, in which a center core (a magnetic path core formed by laminating plural silicon steel plates), a primary coil and a secondary coil are inserted inside the coil case shaped in an elongated cylinder.

The primary and secondary coils are generally wound around the individual bobbins, and placed in a concentric position around the center core. By means of filling and hardening the insulating resin or filling the insulating oil in the coil case containing the primary and secondary coils, the insulating properties of the coil is established.

As for the prior arts, for example, there are found in Japanese Patent Application Laid-Open No. 8-255719 (1996), Japanese Patent Application Laid-Open No. 9-7860 (1997), Japanese Patent Application Laid-Open No. 9-17662 (1997), Japanese Patent Application Laid-Open No. 8-93616 (1996), Japanese Patent Application Laid-open No. 8-97057 (1996), Japanese Patent Application Laid-open No. 8-144916 (1996), Japanese Patent Application Laid-Open No. 8-203757 (1996) and Japanese Patent Application Laid-Open No. 9-167709 (1997). In order to reduce the leakage flux passing through the periphery of the coil, such considerations as a side core is formed on th e periphery of the coil case are taken into the pencil coil.

There are two types of pencil coils; the one in which the primary coil is located inside and the secondary coil is located outside and the other in which the primary coil is located outside and the secondary coil is located outside. The later method (inner secondary coil structure) has an advantageous aspect with respect to output characteristic rather than the former method (outer secondary coil structure).

Suppose a pencil coil which is formed by filling and hardening insulating resin (for example, epoxy resin) in the structural member of the coil, in the outer secondary coil structure, a static stray capacitance occurs between the secondary coil and the low-voltage primary coil inside the secondary coil (supposed to be almost ground voltage) as well as a static stray capacitance occurs also between the secondary coil and the side core (ground voltage). Therefore, in contrast to the inner secondary coil structure, the static stray capacitance gets to be excessive at the side core, and the static stray capacitance in the outer secondary coil structure tends to be larger (note that, in the inner secondary coil structure, as a static stray capacitance occurs between the secondary coil and the primary coil, and the primary coil and the side core are ground voltage, there is substantially no static stray capacitance between the primary coil and the side core).

The secondary voltage output and its rise time characteristic are subject to the static stray capacitance, in which the larger the static stray capacitance, the lower the secondary voltage output and the more its rise time delays. Therefore, it is supposed that the inner secondary coil structure having less static stray capacitance is suited for downsizing the device and attaining the high-power.

In the conventional so-called pencil-coil type ignition coil for the internal combustion engine, the radial thickness of the secondary bobbin is generally uniform from the low-voltage part of the secondary coil to the high-voltage part of the secondary coil, and the thickness of the insulating layer between the secondary coil and the primary coil is also uniform.

In the ignition coil other than independent ignition type (pencil coil type), for example, in the simultaneous ignition type coil for internal combustion engine as disclosed in Japanese Patent Application Laid-Open No. 9-7861 (1997), some are found to be made so that the radial thickness of the both ends of the secondary bobbin (secondary coil bobbin) are made larger than the thickness of the central part in the axial direction of the bobbin. As shown in FIG. 7B, in the simultaneous ignition method, high voltage is generated at the both ends of the secondary coil, and plural ignition plugs, individual ignition plugs connected to one and the other end of the secondary coil, are simultaneously ignited, in which the radial thickness of the both ends of the secondary bobbin is made larger because the voltage at the both ends of the secondary coil is high. When making larger the thickness of the both ends of the secondary bobbin, the coil turn count of the secondary coil at the both ends of the secondary bobbin is made smaller than the coil turn count of the secondary coil at the center of the secondary coil.

In the independent-ignition type coil for internal combustion engine as described in Japanese Patent Application Laid-Open No. 9-283348 (1997), what is known is a technology for establishing a sufficient with stand voltage in the outer secondary coil structure by making larger the insulation distance between either of the high-voltage both ends of the secondary coil by means that the coil turn count at the center of the winding part of the secondary bobbin in the axial direction is made larger than the coil turn count at its both ends (that is, the coil turn count of the secondary coil at the position where the flux linkage is made increased), and that the coil turn count at the both ends of the secondary coil is made smaller (in other words, the thickness of the winding layer at the both ends of the secondary coil).

As an independent-ignition type coil for internal combustion engine is installed inside the plug hole, the space for the coil part is very narrow, and there have been such a problem that an independent-ignition type coil with high-power and high-insulation properties for internal combustion engine is realized.

Especially in an internal secondary coil structure, it is often a case that a center core is placed inside the secondary bobbin, and that flexible epoxy resin (elastomer) and silicon rubber, both at least flexible in an ordinary temperature, are used for the insulative resin filled between the center core and the secondary bobbin in order to reduce the thermal stress between the center core and the secondary bobbin. As the insulating property of those insulative resins is generally lower than the ordinary epoxy resin, reasonable consideration for the material and thickness of the secondary bobbin is an important in order to increase the insulating properties.

As for the material used for the secondary bobbin, polyphenylene sulfide with high insulating performance is well known, and the thickness of the bobbin at the winding part is made uniform in the conventional design. Though the insulating performance can be increased by considering its thickness of the secondary bobbin according to the design of the secondary bobbin of the simultaneous ignition type coil described in Japanese Patent Application Laid-Open No. 9-7861 (1997) (that is, the design concept in which the thickness of the high-voltage side of the secondary bobbin is made thicker than other parts of the secondary bobbin), this design method is not sufficient due to the following reasons.

In the independent-ignition type coil for internal combustion engine, the one end of the secondary coil is connected to the terminal of the primary coil and becomes a low-voltage side, and the other end of the secondary coil becomes a high-voltage side due to the induced voltage and connected to the individual ignition plugs of the internal combustion engine. In this case, therefore, in attempting to make larger the radial thickness of the secondary bobbin at the high-voltage side of the winding part than other parts, it may be of course concluded that the radial thickness of the bobbin at the low-voltage side may not be made larger. This design concept is not sufficient for attaining the high insulating performance in the inner secondary coil structure.

The reason why the above conclusion is induced is described below by referring to FIG. 8.

In FIG. 8, a layout of the center core, the secondary coil and the primary coil of the independent ignition type coil for internal combustion engine and electric potentials at the center core, the secondary coil and the primary coil are shown.

The surrounding area of the center core is insulated, and its electric potential is located between the low-voltage side and the high-voltage side of the secondary coil under the influence of the electric field of the secondary coil. For example, assuming that the voltage at the low-voltage side of the second coil is 0V and the voltage at the high-voltage side of the second coil is −30 kV, the intermediate electric potential is −15 kV. As the electric potential of 15 kV occurs between the center core and the low-voltage side of the secondary coil as well as the high-voltage side of the secondary coil, it is required to increase the insulating property at the low-voltage side of the secondary bobbin (the low-voltage side of the secondary coil).

In case of the inner secondary coil structure, it is required to increase the insulating property between the high-voltage side of the secondary coil and the primary coil.

### SUMMARY OF THE INVENTION

An object of the present invention is to satisfy sufficiently the insulating characteristic and the high power output in the independent ignition type coil for internal combustion engines having an inner secondary coil structure with spatial constraints.

The first invention is characterized by that, in an independent ignition type coil for internal combustion engines used with connection to the individual ignition plugs of the internal combustion engine, in which a center core, a secondary coil wound at the secondary bobbin and the primary coil wound at the primary bobbin are placed concentrically inside the coil case in sequence from the inside of the coil case (so-called inner secondary coil structure), one end of said secondary coil is connected to said primary coil side and becomes a low-voltage side, and the other side becomes a high-voltage side due to the induced voltage, the winding part of said secondary bobbin is characterized by that the radial thickness of the bobbin at the low-voltage side and the high-voltage side of the secondary coil, each located at the both ends of the secondary coil is made larger than the radial thickness of the bobbin at the center part of the secondary coil.

According to the above structure, the insulating performance can be increased by making larger the radial thickness of the secondary bobbin at the low-voltage side and high-voltage side of the secondary coil with their electric potential difference with that of the center core of the secondary coil being larger than others. As there is substantially no electric potential difference between the center part of the secondary coil and the center core, and the radial thickness of the secondary bobbin at this position can be made smaller than that in the conventional coil, it will be appreciated that the radial dimension of the overall ignition coil may not be increased and the output power of the ignition coil may be increased even by increasing the coil turn count of the secondary coil at the central part of the secondary bobbin in the axial direction.

The second invention is characterized by that, in an independent ignition type coil for internal combustion engines having an inner secondary coil structure, the radial thickness of the insulating layer between the secondary coil and the primary coil at the low-voltage side of the secondary coil is smaller and the radial thickness of the insulating layer at the high-voltage side of the secondary coil is larger.

Owing to this structure, a sufficient thickness can be established at the insulating layer at the position where the largest electric potential difference between the secondary coil and the primary coil occurs.

For example, the coil turn count of the secondary coil at the high-voltage side where the electric potential difference with the primary coil is larger is made smaller than the coil turn count of the secondary coil at the low-voltage side where the electric potential difference with the primary coil is smaller, and consequently, the radial thickness of the epoxy resin (the insulating layer between the primary coil and the secondary coil)at the high-voltage side of the primary coil is made larger.

The third invention can be established by combining the component parts of the first and second inventions.

### BRIEF DESCRIPTION OF THE DRAWINGS

FIG. 1 is a partial longitudinal sectional view of the independent ignition type coil for internal combustion engines to which the present invention is to be applied.

FIG. 2 is a longitudinal sectional view of the first embodiment of the present invention.

FIG. 3 is a longitudinal sectional view of the second embodiment of the present invention.

FIG. 4 is a longitudinal sectional view of the third embodiment of the present invention.

FIG. 5 is a longitudinal sectional view of the forth embodiment of the present invention.

FIG. 6 is a circuit diagram of the igniter unit used in the above-mentioned individual embodiments.

FIG. 7A is a schematic diagram of the independent ignition type coil for internal combustion engines to which the present invention is to be applied.

FIG. 7B is a schematic diagram of the conventional simultaneous ignition type coil for internal combustion engines.

FIG. 8 is an illustration showing a layout of the center core, the secondary coil and the primary coil of the independent ignition type coil for internal combustion engine and electric potentials at the center core, the secondary coil and the primary coil.

### DETAILED DESCRIPTION OF THE PREFERRED EMBODIMENTS

Referring to the drawings, an embodiment of the present invention will be explained hereinafter.

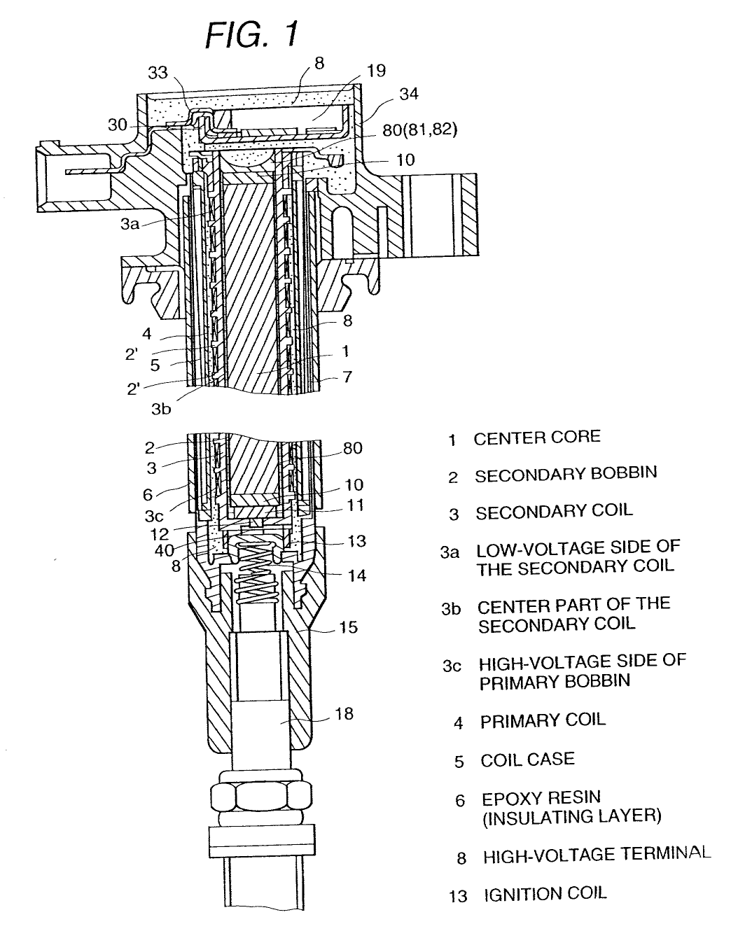

FIG. 1 is a partial longitudinal sectional view of the independent ignition type coil for internal combustion engines to which the present invention is to be applied, and FIGS. 1 to 5 are longitudinal sectional views of the independent ignition type coil for internal combustion engines showing some variations for the thickness of the secondary bobbin and the thickness of the insulating layer between the secondary coil and the primary coil.

Inside the coil case (armored case) 6 shaped in an elongated cylinder, a center core, a secondary coil wound at the secondary bobbin and the primary coil wound at the primary bobbin are placed in sequence from the center (the inside) to the outside, and the thermosetting insulating resin (in this example, epoxy resin) 8 is filled in order to fill the air gap among those components. The flexible epoxy resin (so-called elastomer) 80 which has elasticity at least at the ordinary temperature or higher is filled in the secondary bobbin 2 so as to fill the surrounding area of the magnet 100 placed at the center core 1 and its both ends in order to reduce the thermal stress due to the difference in the linear expansion coefficient between the center core 1 and the secondary bobbin 2. In stead of using the flexible epoxy resin 80, it may be allowed that, a silicon rubber 81 is made laid around the center core 1 and the epoxy resin 8 is filled and hardened between the secondary bobbin 2 and the silicon rubber 81 with evacuated operation (for example, at 4 Torr or less), or that a heat-shrinkable tube 8 which is constricted due to heat is made laid around the center core 1 and the epoxy resin 8 is filled and hardened between the secondary bobbin 2 and the heat-shrinkable tube 8 with evacuated operation (for example, at 4 Torr or less).

A side core 7 is installed on the outside wall of the coil case 6. The side core 7 forms a magnetic path in cooperation with the center core 1, which is formed by wrapping over one to four thin silicon steel plates or oriented silicon steel plates shaped in a cylinder with their individual thickness being from 0.2 mm to 0.5 mm. There is at least one slit on a circumferential position of the side core 7 in order to prevent a single turn short of magnetic flux.

The center core 1 is formed by pressing plural laminated thin plates composed of silicon steel or oriented silicon steel with their individual thickness being from 0.2 mm to 0.5 mm. A magnet 10 is located at the both ends of the center core in its axial direction and adjacently to the center core 1. The magnet 10 is used for operating the ignition coil under the saturation point of the magnetization curve of the core by generating a magnetic flux in the opposite direction to the coil magnetic flux passing through the center core 1. The magnet 10 may be located only on a single end of the center core 1.

A formed rubber plate 11 as a member for buffering the thermal stress is placed so as to be arranged in line with the center core 1 and the magnet 1 in the axial direction in order to absorb the difference in the linear expansion coefficient in the axial direction between the center core 1 and the magnet 10, and the secondary bobbin 2 and the epoxy resin 8.

The coil case 6 is molded with materials such as, for example, polybutylene terphthalate (hereinafter referred to as PBT) and polyphenylene oxide (hereinafter referred to as PPS).

The primary bobbin 4 is molded with thermosetting insulating resin such as, for example, PPS and metamorphic polyphenylene oxide (hereinafter referred to as metamorphic PPO), and the primary coil 5 wound around the primary bobbin 4 is a several-layered laminated coil having totally 100 to 300 turns in which each single coil layer is composed of a coil having 50 to 60 turns formed by an enamel wire having wire diameter of 0.3 mm to 1.0 mm.

The secondary bobbin is also molded with thermosetting insulating resin such as PPS and metamorphic PPO. The secondary bobbin 2 is shaped in a hollow cylinder with a bottom and incorporated inside the second bobbin 2 so that the formed rubber plate 11, the magnet 10 and the center core 1 may be accepted by the bottom of the secondary bobbin having a resin circulation hole 12.

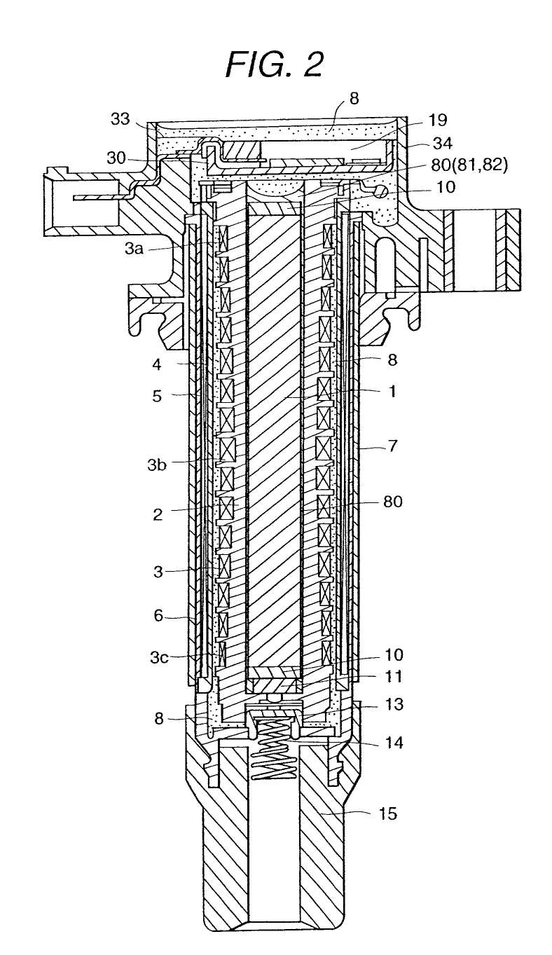

The secondary bobbin 2 has also a role for staying between the center core 1 and the secondary coil 3 and insulating the high voltage generated at the secondary coil 3. The radial thickness of the secondary bobbin 2 is made 0.0 to 1.0 mm in order to insulate the high voltage generated at the secondary coil 3, and the position of the center core 1 is determined so as not to contact the inner wall of the secondary bobbin 2, and fixed by the flexible epoxy 80 filled and hardened with evacuated operation (for example, at 4 Torr or less). In this embodiment, the radial thickness of the bobbin 2 at the winding part is made to change in the axial direction, which will be described by referring to FIGS. 2 to 5.

The secondary coil 3 is formed as a coil having totally 1000 to 30000 turns so as to be distributed at the individual sectors between adjacent collars 2′ on the secondary bobbin 2.

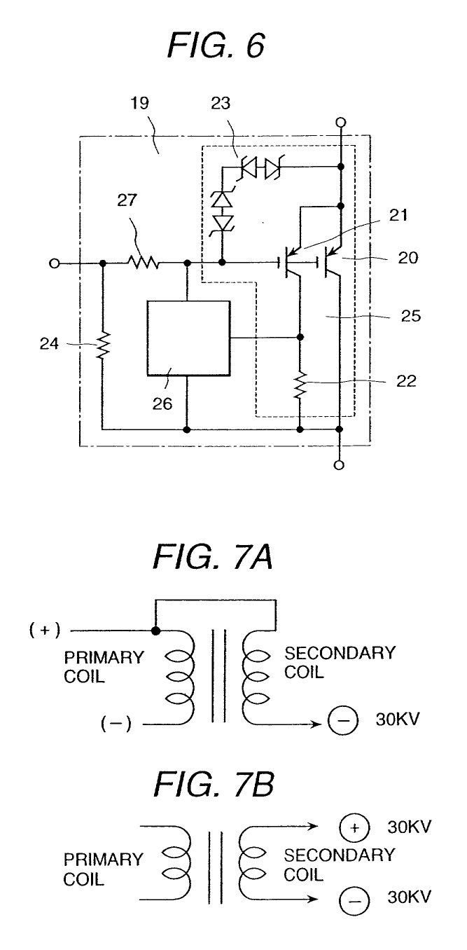

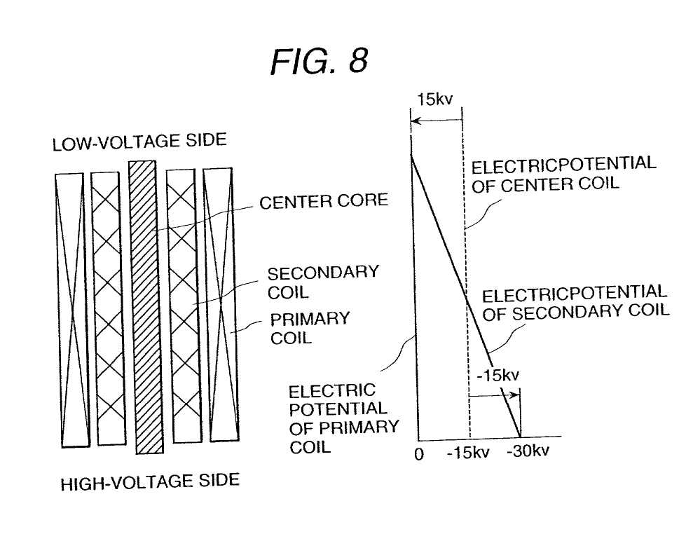

The structure of the drive circuit for the ignition coils is described by referring to FIG. 6 as well as FIG. 1. FIG. 6 shows an example of the structure of the ignition coil drive circuit used in this embodiment.

A unit 19 for the ignition coil drive circuit (hereinafter referred to as igniter) is placed over the coil part composed of the above described center core, primary coil 5 and secondary coil 3 and so on. More concretely, the igniter 19 is incorporated inside the igniter case (circuit case) 34 connected on the top end of the coil case 6, and its surrounding area is covered by epoxy 8 and thus insulated.

As shown in FIG. 6, the igniter 19 is composed by an insulated gate bipolar transistor (hereinafter referred to as IGBT) 25, a current limitation circuit 26 and an input resistance 27 and so on.

IGBT 25 is composed of a main IGBT 20 and a sub IGBT 21.

A current sensing resistor 20 is connected between the emitter of the sub IGBT 21 and the ground (GND). A bi-directional Zener diode 23 composed of polysilicon having a good temperature characteristic is inserted between the gate and the collector of IGBT 25, and the primary voltage is clamped at the voltage from 400 V to 550V. A breeder resistor 24 is inserted between the input and GND, and then, the contact current at the connection part of the input signal is allowed to be 1 mA or larger. The terminal 33 of the igniter shown in FIGS. 1 and 6 is plated, and it is appreciated that a sufficient reliability in electric connection can be established even by Sn plating. A component 30 is a metallic plate composed of Cu or Al for heat radiation.

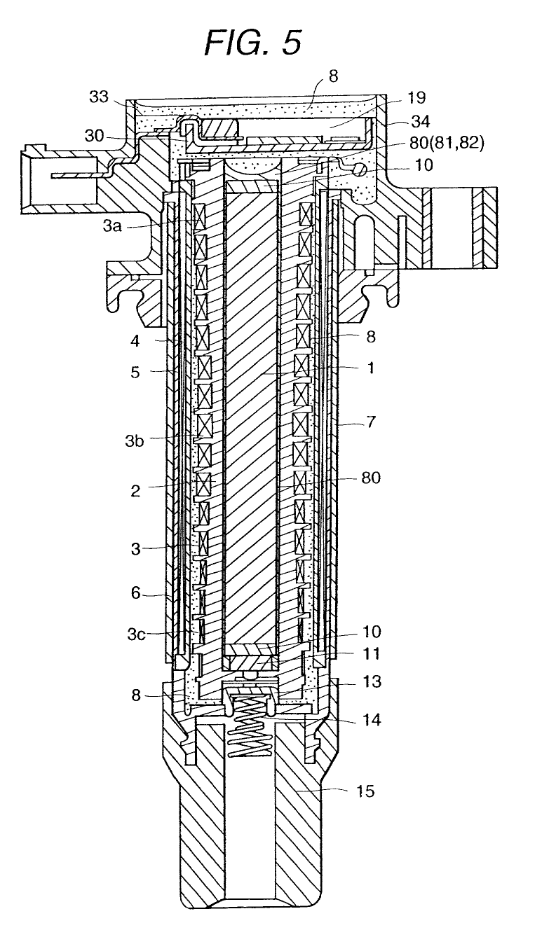

As shown in FIG. 5, one end of the primary coil 5 is connected to the positive terminal of the battery (not shown) and the other end is connected to the igniter 19 so that the electric current is supplied from the igniter 19 and controlled by the igniter 19. On the other hand, one end of the secondary coil 3 is connected to the positive terminal of the battery through the common terminal (primary coil terminal) shared with the primary coil 5 (one end of the secondary coil 3 is defined as a low-voltage side 3a), and the other end defined as a high—voltage side of the primary voltage supply is connected to the high-voltage terminal 13 through the flat spring. According to the above structure, when the electric current is supplied and broken in sequence to the primary coil 5, high voltage is induced at the secondary coil 3, and then the ignition energy is supplied to the ignition plug 18.

The high voltage generated at the secondary coil 3 is supplied to the ignition plug 18 through the spring 14. The part to which the ignition pug 18 is to be inserted is insulated by a rubber boot 15 composed of silicon rubber and so on.

In this embodiment, the radial thickness of the secondary bobbin 2 where the coil is would is changed in its axial direction, in order to insulate the high voltage generated at the secondary coil 3, in which the radial thickness of the bobbin where the center part 3b of the secondary coil is located and the difference in the electric potential with the center core 1 is small is made minimized (for example, about 1 mm), and the radial thickness of the bobbin where the low-voltage side (low-voltage part) 3a and the radial thickness of the bobbin where the high-voltage side (high-voltage part )3c where the difference in the electric potential with the center core 1 is large is made larger (for example, about 1.2 mm).

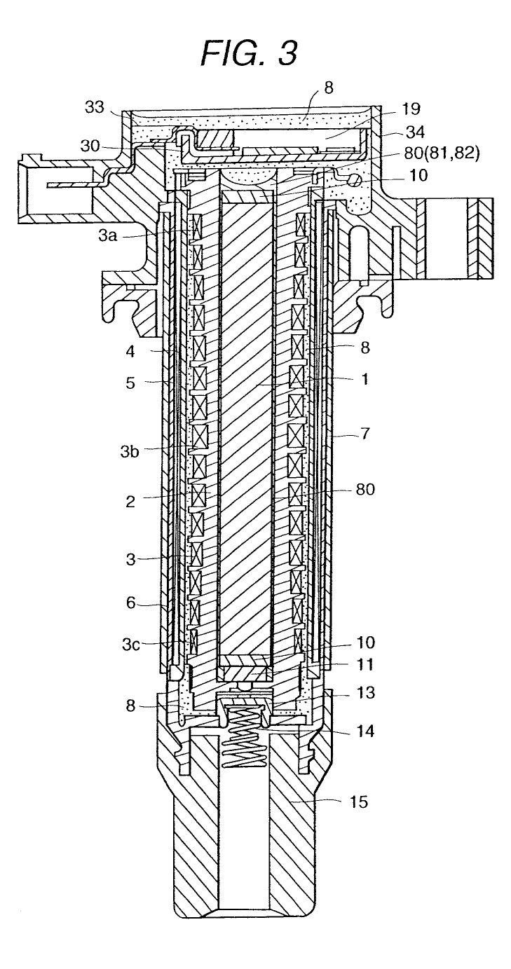

As for the determination of the radial thickness of the secondary bobbin 2, there are several variations including that the radial thickness is made increased stepwise as shown in FIG. 2 from the center part 3b of the secondary coil to the low-voltage side 3a and the high-voltage side 3c of the secondary coil, and that the radial thickness if made increased linearly in a tapered shape as shown in FIG. 3 from the center part 3b of the secondary coil to the low-voltage side 3a and the high-voltage side 3c of the secondary coil.

In the embodiment shown in FIGS. 2 and 3, the space replaced for the reduced radial thickness of the center part of the secondary bobbin 2 in its axial direction is used for increasing the coil turn count (the Number of laminated layers) of the center part 3b of the secondary coil, and in contrast, the space occupied for the increased radial thickness of the secondary bobbin at the both ends corresponding to the low-voltage side 3a and high-voltage side 3c of the secondary coil is used for increasing the coil turn count of the corresponding secondary coil parts, that is, the low-voltage side 3a and the high-voltage side 3b, which leads to keeping a uniform radial thickness of the insulating layer (epoxy resin) 8 between the secondary coil 3 and the primary coil 5 for establishing sufficient insulating performance as well as the primary bobbin 4 does.

The component of the flexible epoxy resin 80 is, for example, a mixture of epoxy resin and metamorphic aliphatic series polyamine (mixture weight ratio is in the proportion of 1 to 1 with epoxy resin 100 weight part and metamorphic aliphatic series polyamine 100 weight part), and its insulating characteristic (break-down voltage) is subject to the temperature and from 10 to 16 kV/mm. In contrast, in case that the material of the secondary bobbin 2 is, for example, PPS, its insulating characteristic is 20 kV/mm, and the insulating characteristic of the epoxy resin 8 is from 16 to 20 kV/mm. Therefore, the insulating function provided by the secondary bobbin 2 between the center core 1 and the secondary coil 3 plays an important role. In this embodiment, as described above, as the radial thickness of the secondary bobbin 2 at the center part 3b of the secondary coil where the difference in the electric potential with the center core 1 is small is made the smallest among other parts, and the radial thickness of the secondary bobbin 2 at the low-voltage side 3a and high-voltage side 3c of the secondary coil where the difference in the electric potential with the center core is large (for example, a difference of 15 kV) is made larger, it will be appreciated that sufficient insulating performance between the secondary coil 3 and the center core 1 can be established, and as the radial thickness of the secondary bobbin corresponding to the center part 3b of the secondary coil can be made smaller than that in the prior art system, it will be appreciated that the diameter of the ignition coil must not be increased even if the coil turn count of the secondary coil at the center part of the secondary bobbin 2 in the axial direction, and that the output power of the ignition coil can be increased by increasing the coil turn count of the secondary ignition coil 3.

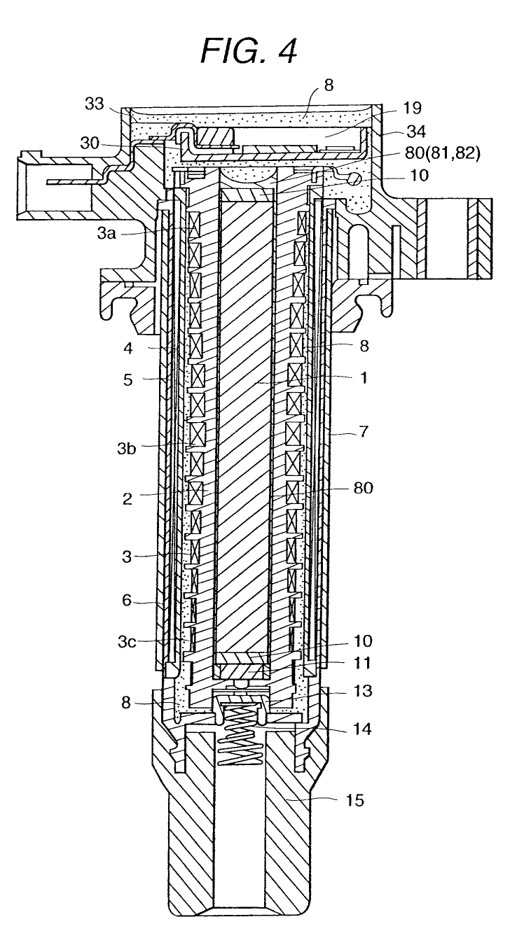

Next, the embodiments shown in FIGS. 4 and 5 is described.

In the embodiment shown in FIG. 4, the radial thickness of the bobbin 2 corresponding to the coil winding part is increased stepwise from the center part 3b of the secondary coil to the low-voltage side 3a and the high-voltage side 3c of the secondary coil in the similar manner to what shown in FIG. 2, and in the embodiment shown in FIG. 5, the radial thickness of the bobbin 2 corresponding to the coil winding part is increased linearly in a tapered shape from the center part 3b of the secondary coil to the low-voltage side 3a and the high-voltage side 3c of the secondary coil in the similar manner to what shown in FIG. 3, and in both embodiments, the radial thickness of the insulating layer (epoxy resin 8) staying between the secondary coil 3 and the primary coil 5 is made smaller at the low-voltage side 3a of the secondary coil and larger at the high-voltage side 3b of the secondary coil.

Considering that the difference in the electric potential between the secondary coil 3 and the primary coil 5 increases in the direction from the low-voltage side 3a of the secondary coil to its high-voltage side 3c, the thickness of the epoxy resin 8 is determined.

In FIGS. 4 and 5, the coil turn count of the secondary coil 3 at the center part 3b is made maximized, and the coil turn count is made increased stepwise from the center part 3b of the secondary coil to the high-voltage side 3c and low-voltage side 3a of the secondary coil, in which the rate of decrease in the coil turn in the direction to the high-voltage side 3c of the secondary coil is made larger than that in the direction to the low-voltage side 3a of the secondary coil. In accordance with this coil turn arrangement and the radial thickness determination described above, the thickness of the epoxy resin (insulating layer) staying between the secondary coil 3 and the primary coil 5 is defined so as to be smaller at the low-voltage side 3a of the secondary coil and larger at the high-voltage side 3b of the secondary coil.

The thickness of the epoxy resin 8 of the primary coil 5 and the secondary coil 3 is, for example, from 0.5 to 1.00 mm at the low-voltage side 3a of the secondary coil, and from 0.5 to 1.5 mm at the high-voltage side 3c of the secondary coil so that the above described condition which means that the thickness at the low-voltage side 3a of the secondary coil is smaller and the thickness at the high-voltage side 3b of the secondary coil is larger may be satisfied.

According to the above described structure, in addition to the effects given by the embodiments shown in FIGS. 2 and 3, it will be appreciated that the insulating characteristic can be satisfied sufficiently with respect to the thickness of the insulating layer between the high-voltage side 3c of the secondary coil and the primary coil 5 which requires high insulating performance, without increasing the diameter of the overall ignition coil.

According to the present invention, it will be appreciated that the diameter of the ignition coil can be reduced (downsizing can be established) and the insulating characteristic and the high power output can be satisfied sufficiently in the independent ignition type coil for internal combustion engines having an inner secondary coil structure with spatial constraints.

What is claimed is:

1. An independent-ignition type coil for an internal combustion engine used with connection to an individual ignition plug of said internal combustion engine, in which a center core, a secondary coil wound at a secondary bobbin and a primary coil wound at a primary bobbin are placed concentrically inside a coil case in sequence from an inside of a coil case, and one end of said secondary coil is connected to said primary coil side and becomes a low-voltage side, and other side becomes a high-voltage side due to an induced voltage, wherein
a winding part of said secondary bobbin is characterized by that a radial thickness of said secondary bobbin at said low-voltage side and said high-voltage side of said secondary coil, each located at both ends of said secondary coil, is made larger than a radial thickness of said secondary bobbin at a center part of said secondary coil.

2. An ignition coil for an internal combustion engine of claim 1, wherein a radial thickness of a wiring part wound at said secondary bobbin is made increased stepwise from a center part of said secondary coil to a low-voltage side and a high-voltage side of said secondary coil.

3. An ignition coil for an internal combustion engine of claim 1, wherein a radial thickness of a wiring part wound at said secondary bobbin is made increased linearly in a tapered shape from a center part of said secondary coil to a low-voltage side and a high-voltage side of said secondary coil.

4. An independent-ignition type coil for an internal combustion engine used with connection to an individual ignition plug of said internal combustion engine, in which a center core, a secondary coil wound at a secondary bobbin and a primary coil wound at a primary bobbin are placed concentrically inside a coil case in sequence from an inside of a coil case, and one end of said secondary coil is connected to said primary coil side and becomes a low-voltage side, and other side becomes a high-voltage side due to an induced voltage, wherein
a radial thickness of an insulating layer between said secondary coil and said primary coil is made smaller at a low-voltage side of said secondary coil and larger at a high-voltage side of said secondary coil.

5. An ignition coil for an internal combustion engine of claim 4, wherein
a radial thickness of an insulating layer between said secondary coil and said primary coil is made smaller at a low-voltage side of said secondary coil and larger at a high-voltage side of said secondary coil by means that a coil turn count is made decreased stepwise from a low-voltage side of said secondary coil to a high-voltage side of said secondary coil.

6. An independent-ignition type coil for an internal combustion engine used with connection to an individual ignition plug of said internal combustion engine, in which a center core, a secondary coil wound at a secondary bobbin and a primary coil wound at a primary bobbin are placed concentrically inside a coil case in sequence from an inside of a coil case, and one end of said secondary coil is connected to said primary coil side and becomes a low-voltage side, and other side becomes a high-voltage side due to an induced voltage, wherein
a winding part of said secondary bobbin is characterized by that;
a radial thickness of said secondary bobbin at said low-voltage side and said high-voltage side of said secondary coil, each located at both ends of said secondary coil, is made larger than a radial thickness of said secondary bobbin at a center part of said secondary coil; and
a radial thickness of an insulating layer between said secondary coil and said primary coil is made smaller at a low-voltage side of said secondary coil and larger at a high-voltage side of said secondary coil.

7. An ignition coil for an internal combustion engine of claim 6, wherein
a coil turn count of said secondary coil at a center part in an axial direction at a wiring part of said secondary bobbin is made maximized;
a coil turn count is made decreased stepwise from said center part of said secondary coil to a high-voltage side and low-voltage side of said secondary coil, in which a rate of decrease in a coil turn count in a direction to said high-voltage side of said secondary coil is made larger than that in a direction to said low-voltage side of said secondary coil; and
according to a coil turn arrangement and a radial thickness determination described above, a radial thickness of an insulating layer between said secondary coil and said primary coil is made smaller at a low-voltage side of said secondary coil and larger at a high-voltage side of said secondary coil.
